(19) United States
(12) Patent Application Publication
(10) Pub. No.: US 2025/0155960 A1
(43) Pub. Date: May 15, 2025

(54) METHOD FOR APPLYING LEARNING MODEL-BASED POWER SAVING MODEL IN INTELLIGENT BMC

(71) Applicant: Korea Electronics Technology Institute, Seongnam-si (KR)

(72) Inventors: Jae Hoon AN, Incheon (KR); Young Hwan KIM, Yongin-si (KR)

(73) Assignee: Korea Electronics Technology Institute, Seongnam-si (KR)

(21) Appl. No.: 18/897,221

(22) Filed: Sep. 26, 2024

(30) Foreign Application Priority Data
Nov. 14, 2023 (KR) 10-2023-0157135

(51) Int. Cl. G06F 1/3296

(52) U.S. Cl. CPC G06F 1/3296

(57) ABSTRACT

There is provided a method for applying a learning model-based power saving model in an intelligent BMC. According to an embodiment, a BMC includes: a prediction module configured to predict future computing resource usage and a future CPU temperature from monitoring data on computing resources; a power capping module configured to control power capping based on the predicted future computing resource usage; a fan control module configured to control a cooling fan based on the predicted future CPU temperature. Accordingly, the BMC effectively/efficiently controls power capping and cooling fans based on prediction by interworking with the on-device AI, thereby reducing power consumption of a data center infrastructure effectively/efficiently.

### CROSS-REFERENCE TO RELATED APPLICATION(S) AND CLAIM OF PRIORITY

This application is based on and claims priority under 35 U.S.C. § 119 to Korean Patent Application No. 10-2023-0157135, filed on Nov. 14, 2023, in the Korean Intellectual Property Office, the disclosure of which is herein incorporated by reference in its entirety.

### BACKGROUND

### Field

The disclosure relates to an intelligent baseboard management controller (BMC), and more particularly, to a method for reducing system operating power consumption by interworking with on-device artificial intelligence (AI).

### Description of Related Art

A BMC refers to a controller that is mounted in a server or a typical computer to provide an interface for managing a system between system management software and a hardware device, and operates in an intelligent platform management interface (IPMI), intelligent platform management bus (IPMB)-based software architecture through the interface.

Due to the increase of power consumption in a data center infrastructure environment, there is a need for a system operating technology for saving total energy by reducing power consumption of server equipment, and in particular, servers in the idle state, which occupy up to 30% of servers existing in the data center, may worsen the problem.

A BMC may be utilized as a means for reducing power consumption of a server since it is appropriate for system management, but has limits to reducing power consumption effectively in terms of the lack of advanced computing power.

### SUMMARY

The disclosure has been developed in order to solve the above-described problems, and an object of the disclosure is to provide an intelligent BMC which effectively/efficiently controls power capping and a cooling fan based on prediction by interworking with on-device AI, as a solution for reducing power consumption of a data center infrastructure.

To achieve the above-described object, a power consumption control method of a computing server according to an embodiment may include: collecting monitoring data on computing resources; predicting future computing resource usage from the collected monitoring data; and controlling power capping based on the predicted future computing resource usage.

Controlling the power capping may include controlling the power capping to reduce idle power of the computing server.

Controlling the power capping may include controlling power capping of a PSU and a CPU core.

Predicting the computing resource usage may include predicting the computing resource usage by receiving a resource usage prediction model that is trained to predict future computing resource usage from monitoring data from an AI model platform, and using the resource usage prediction model.

According to the disclosure, the power consumption control method may further include: predicting a future CPU temperature from the collected monitoring data; and controlling a cooling fan based on the predicted future CPU temperature.

Predicting the CPU temperature may include predicting the CPU temperature by receiving a CPU temperature prediction model that is trained to predict a future CPU temperature from monitoring data from the AI model platform, and using the CPU temperature prediction model.

The resource usage prediction model and the CPU temperature prediction model may be operated in a secondary service processor (SSP) which is distinguished from a primary service processor (PSP) of the BMC.

The PSP and the SSP may communicate through a shared memory.

Data between the PSP and the SSP may include a bit indicating a data transmission entity, a bit distinguishing between a request and a response, a type of requested data, and a content of responded data.

According to another aspect of the disclosure, there is provided a BMC including: a handler configured to collect monitoring data on computing resources; a prediction module configured to predict future computing resource usage from the collected monitoring data; and a power capping module configured to control power capping based on the predicted future computing resource usage.

According to still another aspect of the disclosure, there is provided a power consumption control method of a computing server, the power consumption control method including: predicting future computing resource usage from monitoring data on computing resources; controlling power capping based on the predicted future computing resource usage; predicting a future CPU temperature from the monitoring data on the computing resources; and controlling a cooling fan based on the predicted future CPU temperature.

According to yet another aspect of the disclosure, there is provided a BMC including: a prediction module configured to predict future computing resource usage and a future CPU temperature from monitoring data on computing resources; a power capping module configured to control power capping based on the predicted future computing resource usage; a fan control module configured to control a cooling fan based on the predicted future CPU temperature.

According to embodiments of the disclosure as described above, the BMC effectively/efficiently controls power capping and cooling fans based on prediction by interworking with the on-device AI, thereby reducing power consumption of a data center infrastructure effectively/efficiently.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a configuration of an intelligent BMC according to an embodiment of the disclosure;

FIG. 2 is a view illustrating a communication protocol between a primary service processor (PSP) and a secondary service processor (SSP) of the intelligent BMC; and

FIG. 3 is a view illustrating a power consumption reducing method according to another embodiment of the disclosure.

### DETAILED DESCRIPTION

Hereinafter, the disclosure will be described in more detail with reference to the accompanying drawings.

Embodiments of the disclosure provide an intelligent BMC which reduces power consumption of a server by interworking a smart fan algorithm and power capping with an on-device AI prediction module.

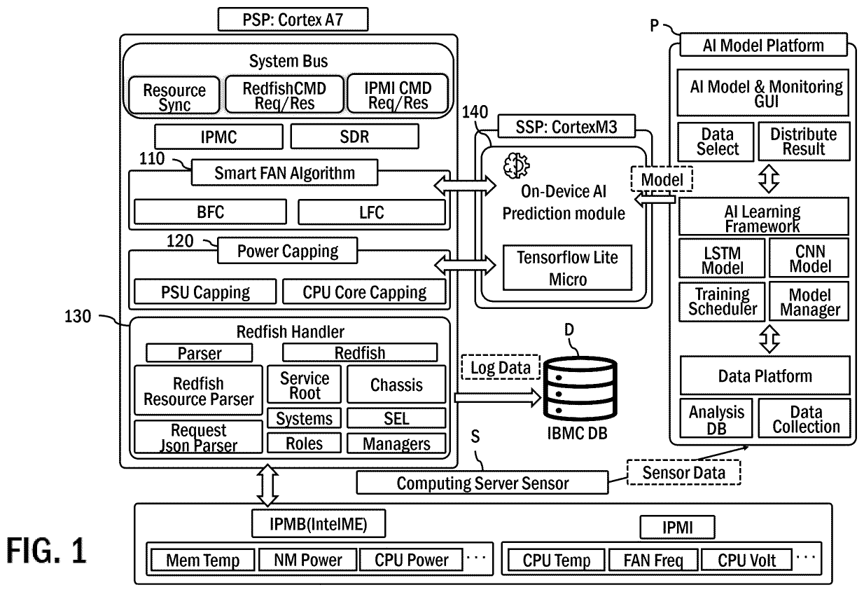

FIG. 1 is a view illustrating a configuration of an intelligent BMC according to an embodiment. For the convenience of understanding and explanation, FIG. 1 further illustrates sensors S, a database (DB) D, an AI model platform P, in addition to the intelligent BMC.

The intelligent BMC may include a smart fan algorithm module 110, a power capping module 120, a redfish handler 130, and an on-device AI prediction module 140 as shown in the drawing.

The redfish handler 130 may collect monitoring information on computing modules which are installed on a main board through the sensors S. Communication between the redfish handler 130 and the sensors S may be performed through an intelligent power module controller (IPMC), a sensor data recorder (SDR) based on a system DBus.

The collected monitoring information may include information on various states of a server, such as temperature, humidity, power, in addition to state information of the computing modules. In an embodiment of the disclosure, important state information may be information on computing resource usage and power and temperature of a central processing unit (CPU).

Monitoring data collected by the redfish handler 130 may be provided to the on-device AI prediction module 140.

The on-device AI prediction module 140 may predict a future CPU temperature from monitoring data by using a CPU temperature prediction model. The CPU temperature prediction model may be an AI model that is trained to analyze monitoring data and to predict a future CPU temperature. In predicting a future CPU temperature, reference may further be made to data related to a fan rotation speed, CPU power, in addition to temperature data of the CPU.

The on-device AI prediction module 140 may predict future computing resource usage from monitoring data by using a resource usage prediction model. The resource usage prediction model may be an AI model that is trained to analyze a server using pattern of a user grasped from monitoring data and to predict future computing resource usage. In predicting future computing resource usage, reference may be made to data related to resource (CPU, memory) usage, total power, CPU power.

The CPU temperature prediction model and the resource usage prediction model, which are AI models, may be trained by the AI model platform P. To achieve this, monitoring information collected through the sensors S may be provided to the AI model platform P to be used as training data for the AI models.

The on-device AI prediction module 140 may configure an AI model with AI model training data received from the AI model platform P, and may predict a future CPU temperature and computing resource usage.

The smart fan algorithm module 110 may reduce cooling power of a computing server by controlling rotation speeds of cooling fans through the redfish handler 130, based on the future CPU temperature predicted by the on-device AI prediction module 140.

The power capping module 120 may reduce idle power of the computing server by controlling power capping of a power supply unit (PSU) and a CPU core through the redfish handler 130, based on the future computing resource usage predicted by the on-device AI prediction module 140.

In addition to the monitoring data collected by the redfish handler 130, a prediction history of the on-device AI prediction module 140 and a control history of the smart fan algorithm module 110 and the power capping module 120 may be stored in the DB D as log data.

The on-device AI prediction module 140 may be implemented by a secondary service processor (SSP), which is distinguished from a primary service processor (PSP) of the intelligent BMC, to operate an AI model as a tiny engine.

Accordingly, an AI model may be operated in the SSP of the Cortex M3 environment, and main board control firmware may be operated in the PSP of the Cortex A7 environment. A shared memory technique may be used to perform communication of a process operating in the two processors PSP, SSP.

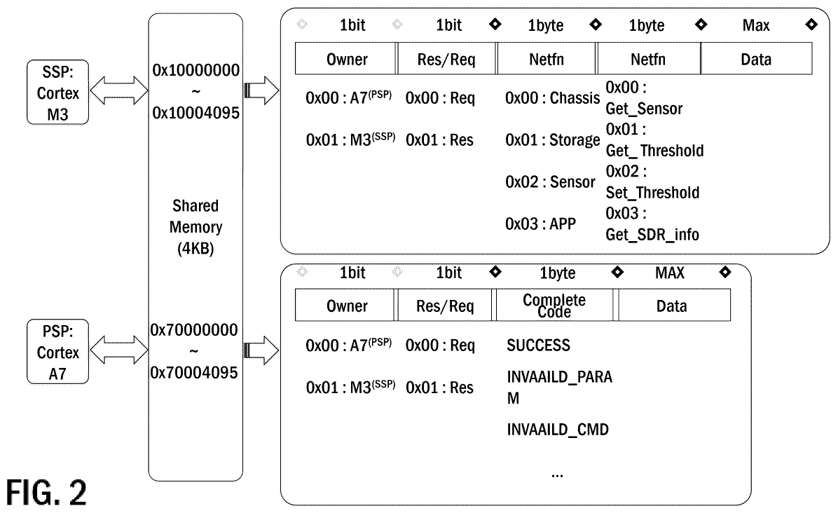

Specifically, as shown in FIG. 2, among memory areas embedded in the intelligent BMC, the SSP operating in the Cortex M3 environment may use memory areas between 0x10000000 and 0x10004095 as shared memory areas, and the PSP operating in the Cortex A7 may use memory areas of 0x70000000 to 0x70004095 as shared memory areas. Here, the 0x10000000 and 0x70000000 addresses may correspond to each other one by one as much as 4 KB.

In FIG. 2, a data communication protocol between the SSP and the PSP is defined through corresponding shared memory areas. The first bit is an owner bit that determines whether data is data that is transmitted from the PSP of the Cortex A7 environment or data that is transmitted from the SPS of the Cortex M3 environment. The second bit is a Res/Req bit that distinguishes between a request and a response, and subsequent areas thereof are configured by a type of requested data, a content of responded data.

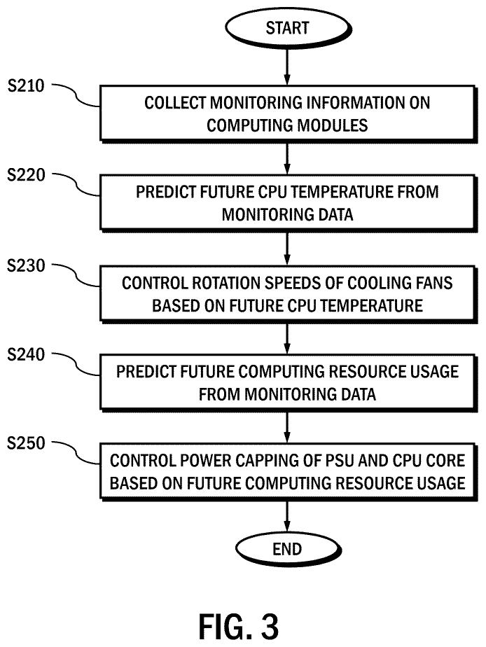

FIG. 3 is a view illustrating a flow of a power consumption reducing method of a server by the intelligent BMC according to another embodiment of the disclosure.

To reduce power consumption, the redfish handler 130 collects monitoring information on the computing modules installed on the main board through the sensors S (S210). The monitoring data collected at step S210 is provided to the on-device AI prediction module 140.

The on-device AI prediction module 140 predicts a future CPU temperature from the monitoring data by using the CPU temperature prediction model (S220). The smart fan algorithm module 110 controls rotation speeds of cooling fans through the redfish handler 130 based on the future CPU temperature predicted at step S220 (S230) to reduce cooling power of the computing server.

The on-device AI prediction module 140 predicts future computing resource usage from the monitoring data by using the resource usage prediction model (S240). The power capping module 120 controls power capping of the PSU and the CPU core through the redfish handler 130, based on the future computing resource usage predicted at step S240 (S250) to reduce idle power of the computing server.

Up to now, the intelligent BMC which reduces power consumption of the server by interworking the smart fan algorithm and the power capping with the on-device AI prediction module has been described with reference to preferred embodiments.

In the above-described embodiments, the BMC effectively/efficiently controls power capping and cooling fans based on prediction by interworking with the on-device AI, thereby reducing power consumption of a data center infrastructure effectively/efficiently.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A power consumption control method of a computing server, the power consumption control method comprising:
collecting monitoring data on computing resources;
predicting future computing resource usage from the collected monitoring data; and
controlling power capping based on the predicted future computing resource usage.

2. The power consumption control method of claim 1, wherein controlling the power capping comprises controlling the power capping to reduce idle power of the computing server.

3. The power consumption control method of claim 2, wherein controlling the power capping comprises controlling power capping of a PSU and a CPU core.

4. The power consumption control method of claim 3, wherein predicting the computing resource usage comprises predicting the computing resource usage by receiving a resource usage prediction model that is trained to predict future computing resource usage from monitoring data from an AI model platform, and using the resource usage prediction model.

5. The power consumption control method of claim 4, further comprising:
predicting a future CPU temperature from the collected monitoring data; and
controlling a cooling fan based on the predicted future CPU temperature.

6. The power consumption control method of claim 5, wherein predicting the CPU temperature comprises predicting the CPU temperature by receiving a CPU temperature prediction model that is trained to predict a future CPU temperature from monitoring data from the AI model platform, and using the CPU temperature prediction model.

7. The power consumption control method of claim 6, wherein the resource usage prediction model and the CPU temperature prediction model are operated in a SSP which is distinguished from a PSP of the BMC.

8. The power consumption control method of claim 7, wherein the PSP and the SSP communicate through a shared memory.

9. The power consumption control method of claim 8, wherein data between the PSP and the SSP comprises a bit indicating a data transmission entity, a bit distinguishing between a request and a response, a type of requested data, and a content of responded data.

10. A BMC comprising:
a handler configured to collect monitoring data on computing resources;
a prediction module configured to predict future computing resource usage from the collected monitoring data; and
a power capping module configured to control power capping based on the predicted future computing resource usage.

11. A power consumption control method of a computing server, the power consumption control method comprising:
predicting future computing resource usage from monitoring data on computing resources;
controlling power capping based on the predicted future computing resource usage;
predicting a future CPU temperature from the monitoring data on the computing resources; and
controlling a cooling fan based on the predicted future CPU temperature.
